(19) United States
(12) Patent Application Publication
(10) Pub. No.: US 2016/0123547 A1
(43) Pub. Date: May 5, 2016

(54) LUMINAIRE FOR CROSSWALK

(71) Applicant: 3M INNOVATIVE PROPERTIES COMPANY, St. Paul, MN (US)

(72) Inventors: Karl J.L. Geisler, St. Paul, MN (US); David G. Freier, St. Paul, MN (US)

(21) Appl. No.: 14/893,099

(22) PCT Filed: May 27, 2014
(86) PCT No.: PCT/US2014/039563

§ 371 Date: Nov. 23, 2015

Related U.S. Application Data
(60) Provisional application No. 61/829,511, filed on May 31, 2013.

(51) Int. Cl. F21S 8/08; F21V 7/00; E01C 1/00; F21V 5/08; F21V 11/14; E01F 9/20; F21S 9/03; F21V 5/00

(52) U.S. Cl. CPC F21S 8/083; F21S 9/03; F21V 7/0008; F21V 5/005; F21V 5/008; F21V 5/08; F21V 11/14; E01F 9/20; E01C 1/002; F21Y 2101/02; F21W 2131/103

(57) ABSTRACT

The present disclosure describes light delivery and distribution components of a light duct that can be used as a luminaire, such as a bollard-style luminaire that can be useful for the illumination of pedestrian crosswalks. The bollard luminaire includes a design that generally confines light to illuminate the cross-walk and the pedestrian in the crosswalk, such that light that could produce glare for the pedestrian and/or a driver approaching the crosswalk is minimized The delivery and distribution system (i.e., light duct and light duct extractor) can function effectively with any light source that is capable of delivering light which is substantially collimated about the longitudinal axis of the light duct, and which is also preferably substantially uniform over the inlet of the light duct.

### BACKGROUND

The potential for greatest vehicle safety advancements are in emerging economies, and in particular rural areas of developed countries. Reduced visibility at night is a key contributor to pedestrian fatalities due to vehicle/pedestrian collisions. It is desired to improve the illumination of pedestrians in crosswalks while preventing excessive glare that may endanger both drivers and pedestrians.

### SUMMARY

The present disclosure describes light delivery and distribution components of a light duct that can be used as a luminaire, such as a bollard-style luminaire that can be useful for the illumination of pedestrian crosswalks. The bollard luminaire includes a design that generally confines light to illuminate the crosswalk and the pedestrian in the crosswalk, such that light that could produce glare for the pedestrian and/or a driver approaching the crosswalk is minimized The delivery and distribution system (i.e., light duct and light duct extractor) can function effectively with any light source that is capable of delivering light which is substantially collimated about the longitudinal axis of the light duct, and which is also preferably substantially uniform over the inlet of the light duct.

In one aspect, the present disclosure provides a luminaire that includes a light duct having a longitudinal axis, light input end, an opposing end, and a reflective interior surface surrounding a cavity; a light output region including a plurality of voids disposed in the reflective interior surface, whereby light can exit the cavity; and an asymmetric turning film. The asymmetric turning film includes a first surface including parallel prismatic microstructures, each having a vertex adjacent the light output region and aligned perpendicular to the longitudinal axis; and an opposing second planar surface, wherein each vertex includes a prism angle having a bisector that is perpendicular to the longitudinal axis and the opposing second planar surface, the bisector dividing the prism angle into a first vertex angle proximate the light input end and a different second vertex angle proximate the opposing end.

In another aspect, the present disclosure provides a luminaire that includes a light duct having a longitudinal axis, light input end, an opposing end, and a reflective interior surface surrounding a cavity; a light output region including a plurality of voids disposed in the reflective interior surface, whereby light can exit the cavity; an asymmetric turning film; and a light source disposed to inject a light beam into the light duct through the light input end. The asymmetric turning film includes a first surface including parallel prismatic microstructures, each having a vertex adjacent the light output region and aligned perpendicular to the longitudinal axis; and an opposing second planar surface, wherein each vertex includes a prism angle having a bisector that is perpendicular to the longitudinal axis and the opposing second planar surface, the bisector dividing the prism angle into a first vertex angle proximate the light input end and a different second vertex angle proximate the opposing end.

In yet another aspect, the present disclosure provides a method of illuminating a pedestrian cross-walk that includes positioning at least one luminaire on a roadway adjacent a pedestrian cross-walk. The luminaire includes a light duct having a longitudinal axis, light input end, an opposing end, and a reflective interior surface surrounding a cavity; a light output region including a plurality of voids disposed in the reflective interior surface, whereby light can exit the cavity; an asymmetric turning film; and a light source disposed to inject a light beam into the light duct through the light input end. The asymmetric turning film includes a first surface including parallel prismatic microstructures, each having a vertex adjacent the light output region and aligned perpendicular to the longitudinal axis; and an opposing second planar surface, wherein each vertex includes a prism angle having a bisector that is perpendicular to the longitudinal axis and the opposing second planar surface, the bisector dividing the prism angle into a first vertex angle proximate the light input end and a different second vertex angle proximate the opposing end. The luminaire is positioned adjacent the cross-walk such that the longitudinal axis is positioned vertically The method of illuminating a pedestrian cross-walk further includes energizing the light source such that the cross-walk is illuminated while reducing illumination of surrounding areas.

The above summary is not intended to describe each disclosed embodiment or every implementation of the present disclosure. The figures and the detailed description below more particularly exemplify illustrative embodiments.

### BRIEF DESCRIPTION OF THE DRAWINGS

Throughout the specification reference is made to the appended drawings, where like reference numerals designate like elements, and wherein:

FIG. 1 shows a perspective schematic view of an illuminated pedestrian crosswalk;

FIG. 2A shows an exploded perspective schematic view of a lighting element;

FIG. 2B shows a perspective schematic view of a lighting element;

FIG. 2C shows a schematic cross sectional side view of a portion of a lighting element;

FIG. 2D shows a cross-sectional schematic side view of a luminaire;

FIG. 2E shows a cross-sectional schematic side view of a luminaire; and

FIG. 2F shows a cross-sectional schematic view of a luminaire.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

The present disclosure describes light delivery and distribution components of a light duct that can be used as a luminaire, such as a bollard-style luminaire that can be useful for the illumination of pedestrian crosswalks. The described bollard-style luminaire can be a light duct positioned vertically from the sidewalk or pavement surface that provides vertical illumination of pedestrians in a crosswalk for enhanced conspicuity and minimal glare. Studies evaluating various crosswalk pedestrian illumination strategies have been conducted, and initial tests of bollard-style luminaires have been shown to be promising candidates. The disclosed bollard luminaire employs a hollow light duct having appropriately designed turning (and optionally steering) films to efficiently deliver highly-collimated light within the crosswalk area, in order to maximize visual contrast between pedestrians in the crosswalk and the background environment. The fixture may be integrated with crosswalk controls either by hardwiring the controls or by wireless addressing, and/or powered by batteries that can be charged during daylight hours by solar cells or other energy harvesting technologies, for off-grid installation such as for temporary uses, or remote installations.

In the following description, reference is made to the accompanying drawings that forms a part hereof and in which are shown by way of illustration. It is to be understood that other embodiments are contemplated and may be made without departing from the scope or spirit of the present disclosure. The following detailed description, therefore, is not to be taken in a limiting sense.

All scientific and technical terms used herein have meanings commonly used in the art unless otherwise specified. The definitions provided herein are to facilitate understanding of certain terms used frequently herein and are not meant to limit the scope of the present disclosure.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

Spatially related terms, including but not limited to, “lower,” “upper,” “beneath,” “below,” “above,” and “on top,” if used herein, are utilized for ease of description to describe spatial relationships of an element(s) to another. Such spatially related terms encompass different orientations of the device in use or operation in addition to the particular orientations depicted in the figures and described herein. For example, if an object depicted in the figures is turned over or flipped over, portions previously described as below or beneath other elements would then be above those other elements.

As used herein, when an element, component or layer for example is described as forming a “coincident interface” with, or being “on” “connected to,” “coupled with” or “in contact with” another element, component or layer, it can be directly on, directly connected to, directly coupled with, in direct contact with, or intervening elements, components or layers may be on, connected, coupled or in contact with the particular element, component or layer, for example. When an element, component or layer for example is referred to as being “directly on,” “directly connected to,” “directly coupled with,” or “directly in contact with” another element, there are no intervening elements, components or layers for example. As used herein, “have”, “having”, “include”, “including”, “comprise”, “comprising” or the like are used in their open ended sense, and generally mean “including, but not limited to.” It will be understood that the terms “consisting of” and “consisting essentially of” are subsumed in the term “comprising,” and the like.

Mirror-lined light ducts can efficiently deliver light from small light sources to be extracted and directed as desired to illuminate regions, such as pedestrian crosswalks. Such mirror-lined light ducts can be uniquely enabled by the use of optical films available from 3M Company, including mirror films such as Vikuiti™ ESR film, that have greater than 98% specular reflectivity across the visible spectrum of light. The design of a crosswalk illumination system takes into consideration the potential glare that can be hazardous to both pedestrians and drivers, and as such, the illumination area is preferably controlled such that minimal light is projected from the luminaire to either the pedestrian's eyes or the driver's eyes. Suitable control of light can be realized by using well-collimated light within the luminaire, and controlling the collimation and direction of light extracted from the luminaire.

Light emitting diode (LED) based lighting may eventually replace a substantial portion of the world's installed base of incandescent, fluorescent, metal halide, and sodium-vapor fixtures, and can be particularly well suited for use in remote illumination systems. One of the primary driving forces is the projected luminous efficacy of LEDs versus those of these other sources. Some of the challenges to utilization of LED lighting include (1) reduce the maximum luminance emitted by the luminaire far below the luminance emitted by the LEDs (e.g., to eliminate glare); (2) promote uniform contributions to the luminance emitted by the luminaire from every LED in the fixture (i.e., promote color mixing and reduce device-binning requirements); (3) preserve the small etendue of LED sources to control the angular distribution of luminance emitted by the luminaire (i.e., preserve the potential for directional control); (4) avoid rapid obsolescence of the luminaire in the face of rapid evolution of LED performance (i.e., facilitate updates of LEDs without replacement of the luminaire); (5) facilitate access to customization of luminaires by users not expert in optical design (i.e., provide a modular architecture); and (6) manage the thermal flux generated by the LEDs so as to consistently realize their entitlement performance without excessive weight, cost, or complexity (i.e., provide effective, light-weight, and low-cost thermal management).

When coupled to a collimated LED light source, the ducted luminaire system described herein can address challenges (1)-(5) in the following manners (challenge 6 concerns specific design of the LED lighting element):

(1) The light flux emitted by the LEDs is emitted from the luminaire with an angular distribution of luminance which is substantially uniform over the emitting area. The emitting area of the luminaire is typically many orders of magnitude larger than the emitting area of the devices, so that the maximum luminance is many orders of magnitude smaller.

(2) The LED devices in any collimated source can be tightly clustered within an array occupying a small area, and all paths from these to an observer involve substantial distance and multiple bounces. For any observer in any position relative to the luminaire and looking anywhere on the emitting surface of a luminaire, the rays incident upon your eye can be traced within its angular resolution backwards through the system to the LED devices. These traces will land nearly uniformly distributed over the array due to the multiple bounces within the light duct, the distance travelled, and the small size of the array. In this manner, an obeserver's eye cannot discern the emission from individual devices, but only the mean of the devices.

(3) The typical orders of magnitude increase in the emitting area of the luminaire relative to that of the LEDs implies a concomitant ability to tailor the angular distribution of luminance emitted by the luminaire, regardless of the angular distribution emitted by the LEDs. The emission from the LEDs is collimated by the source and conducted to the emitting areas through a mirror-lined duct which preserves this collimation. The emitted angular distribution of luminance is then tailored within the emitting surface by the inclusion of appropriate microstructured surfaces. Alternately, the angular distribution in the far field of the luminaire is tailored by adjusting the flux emitted through a series of perimeter segments which face different directions. Both of these means of angular control are possible only because of the creation and maintenance of collimation within the light duct.

(4) By virtue of their close physical proximity, the LED sources can be removed and replaced without disturbing or replacing the bulk of the lighting system.

(5) Each performance attribute of the system is influenced primarily by one component. For example, the local percent open area of the perforated ESR determines the spatial distribution of emission, and the shape of optional decollimation-film structures (also referred to herein as “steering film” structures) largely determines the cross-duct angular distribution. It is therefore feasible to manufacture and sell a limited series of discrete components (e.g., perforated ESR with a series of percent open areas, and a series of decollimation films for standard half angles of uniform illumination) that enable users to assemble an enormous variety of lighting systems.

One component of the light ducting portion of an illumination system is the ability to extract light from desired portions of the light duct efficiently, and without adversely degrading the light flux passing through the light duct to the rest of the ducted lighting system. Extraction of light from hollow light ducts is described further in, for example, co-pending U.S. patent application Ser. No. 61/720118, entitled RECTANGULAR LIGHT DUCT EXTRACTION (Attorney Docket No. 70058US002); and 61/720124, entitled CURVED LIGHT DUCT EXTRACTION (Attorney Docket No. 70224US002) both filed Oct. 30, 2012 and included herein by reference.

For those devices designed to transmit light from one location to another, such as a light duct, it is desirable that the optical surfaces absorb and transmit a minimal amount of light incident upon them while reflecting substantially all of the light. In portions of the device, it may be desirable to deliver light to a selected area using generally reflective optical surfaces and to then allow for transmission of light out of the device in a known, predetermined manner In such devices, it may be desirable to provide a portion of the optical surface as partially reflective to allow light to exit the device in a predetermined manner, as described herein.

Where multilayer optical film is used in any optical device, it will be understood that it can be laminated to a support (which itself may be transparent, opaque reflective or any combination thereof) or it can be otherwise supported using any suitable frame or other support structure because in some instances the multilayer optical film itself may not be rigid enough to be self-supporting in an optical device.

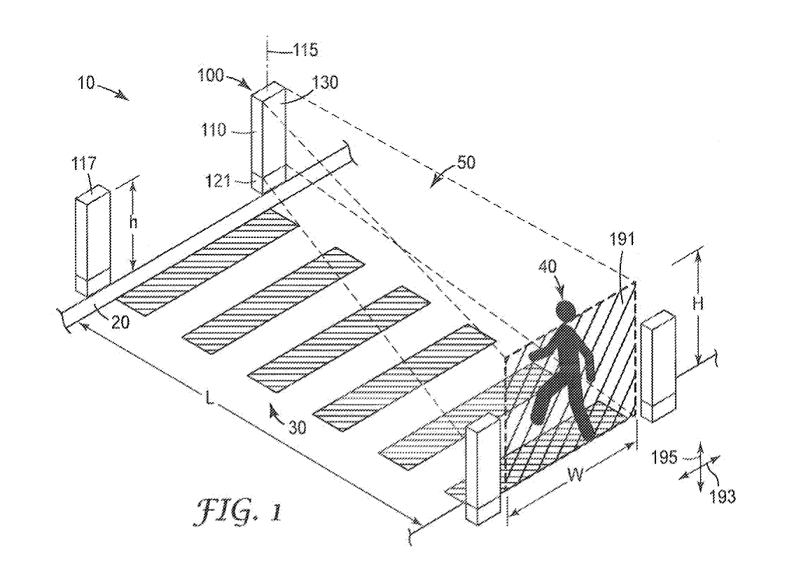

Generally, the combination of the positioning and distribution of the plurality of voids, the structured surface of the asymmetric turning film, and the structured surface of the steering film can be independently adjusted to control the direction and collimation of the light beams exiting through the light duct extractor. Control of the emission in the down-duct direction can be influenced by the distribution of the plurality of voids and the structure of the asymmetric turning film disposed adjacent the plurality of voids. Control of the emission in the cross-duct direction can also be influenced by the distribution of the plurality of voids, and the structure of the steering film disposed adjacent the asymmetric turning film. This is illustrated in FIG. 1 for a bollard luminaire and a vertical target surface. Different locations of the luminaire can illuminate different localized areas on the target surface, as described elsewhere. Tailoring the percent open area of the perforated ESR at different locations to alter the local intensity of the emitted luminance provides the means to create desired patterns of illuminance on the target surface.

FIG. 1 shows a perspective schematic view of an illuminated pedestrian crosswalk 10, according to one aspect of the disclosure. Illuminated pedestrian crosswalk 10 includes curb 20, crosswalk 30, pedestrian 40, illumination light rays 50, and at least one luminaire, such as a bollard luminaire 100 having a luminaire height “h”. In FIG. 1, four bollard luminaires 100 are shown, each disposed adjacent the crosswalk 30 on the curb 20. Each of the bollard luminaires 100 can have any desired cross-sectional shape including, for example, a rectangle such as shown in FIG. 1, a circle, an ellipse, a rectangle having at least one curved surface, or any desired polygonal or curvilinear cross-sectional shape.

Bollard luminaire 100 includes a light duct 110 having a longitudinal axis 115 and a reflective inner surface surrounding a cavity. A light source 121 injects a partially collimated light beam (not shown) along the longitudinal axis 115 within the light duct 110. A portion of the partially collimated light beam can leave the light duct 110 through a light output surface 130 where light is extracted through a plurality of voids, as described elsewhere. In general, any desired number of light output surfaces can be disposed at different locations on any of the light ducts described herein.

Illumination light rays 50 leaving the light output surface 130 are directed onto an illumination region 191 adjacent crosswalk 30. The illumination region 191 can be positioned as desired along a first direction 193 perpendicular to the longitudinal axis 115 and also along a second direction 195 parallel to the longitudinal axis 115. The size and shape of the illumination region 191 can also be varied, by adjusting a distribution of voids, an asymmetric turning film, and an optional steering film (not shown) from the light duct 110, as described elsewhere. The light rays that leave the light output surface 130 can be configured to create any desired level and pattern of illumination on the illumination region 191, and generally includes an illumination height “H” and an illumination width “W” that illuminate a pedestrian in the crosswalk without producing glare in the pedestrian's eyes (or driver's eyes when approaching the crosswalk), as described elsewhere. In one particular embodiment, the bollard luminaire 100 can have the overall luminaire height “h” of about 4 feet (the top 3 feet of which is capable of emitting light), the illumination height “H” can be less than an average height of an adult pedestrian's eyes above the crosswalk, for example, about 5 feet (152 cm), and the illumination width “W” can be about the width of the crosswalk, for example, about 8 feet (244 cm).

In one particular embodiment, the partially collimated light beam (not shown) includes a cone of light having a propagation direction within a collimation half-angle from a central light ray, as described elsewhere. The divergence angle of the partially collimated light beam can be symmetrically distributed in a cone around the central light ray, or it can be non-symmetrically distributed. In some cases, the divergence angle of the partially collimated light beam can range from about 0 degrees to about 30 degrees, or from about 0 degrees to about 25 degrees, or from about 0 degrees to about 20 degrees, or even from about 0 degrees to about 15 degrees, or less than about 10 degrees. In one particular embodiment, the divergence angle of the partially collimated light beam can be less than about 10 degrees, to provide for acceptable levels of illumination glare for both pedestrians and drivers.

Partially collimated light rays are injected into the interior of the light duct along the direction of the axis of the light duct. A perforated reflective lining of the light duct (e.g., perforated 3M Enhanced Specular Reflector (ESR) film) lines a portion of the light duct. A light ray which strikes the ESR between perforations is specularly reflected and returned to the light duct within the same cone of directions as the incident light. Generally, the reflective lining of ESR is at least 98 percent reflective at most visible wavelengths, with no more than 2 percent of the reflected light directed more than 0.5 degrees from the specular direction. A light ray which strikes within a perforation (or void) passes through the ESR with no change in direction. (Note that the dimensions of the perforations within the plane of the ESR are assumed large relative to its thickness, so that very few rays strike the interior edge of a perforation.) The probability that a ray strikes a perforation and therefore exits the light duct is proportional to the local percent open area of the perforated ESR. Thus, the rate at which light is extracted from the light duct can be controlled by adjusting this percent open area.

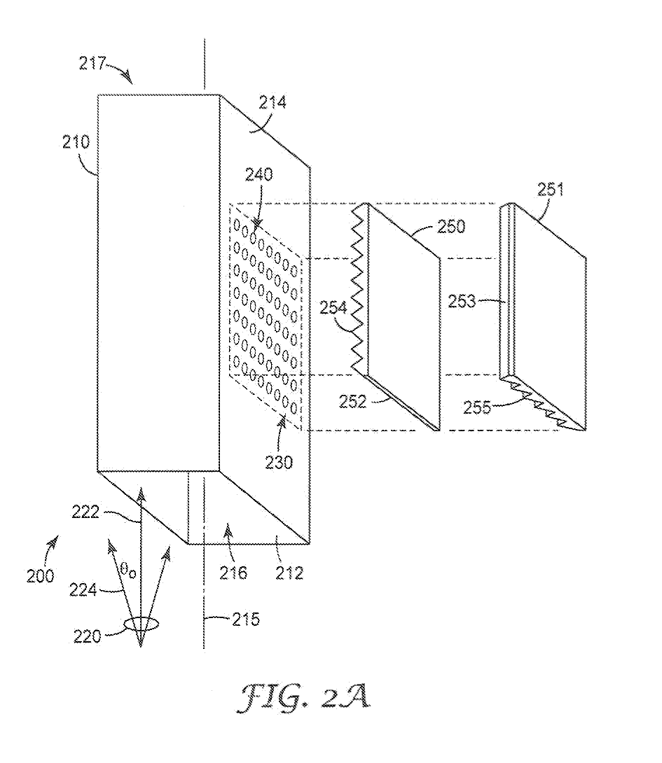

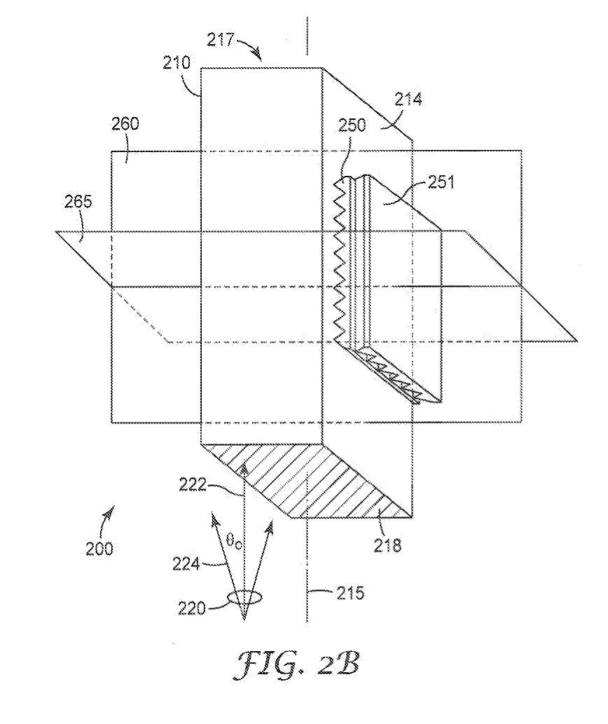

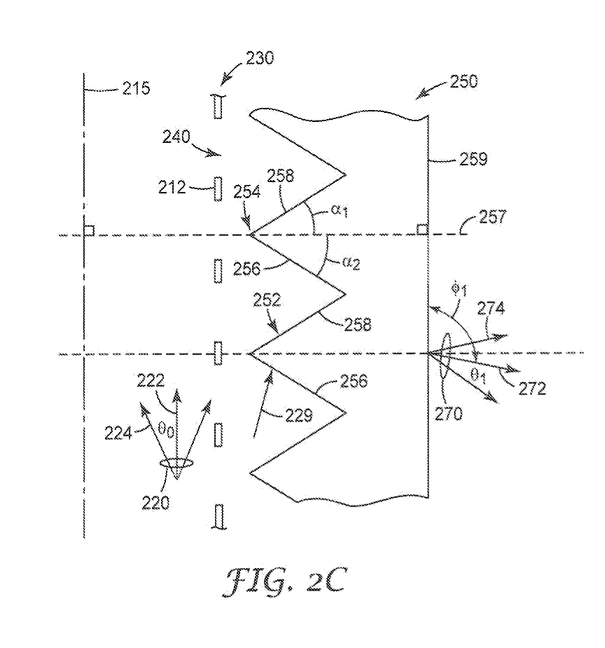

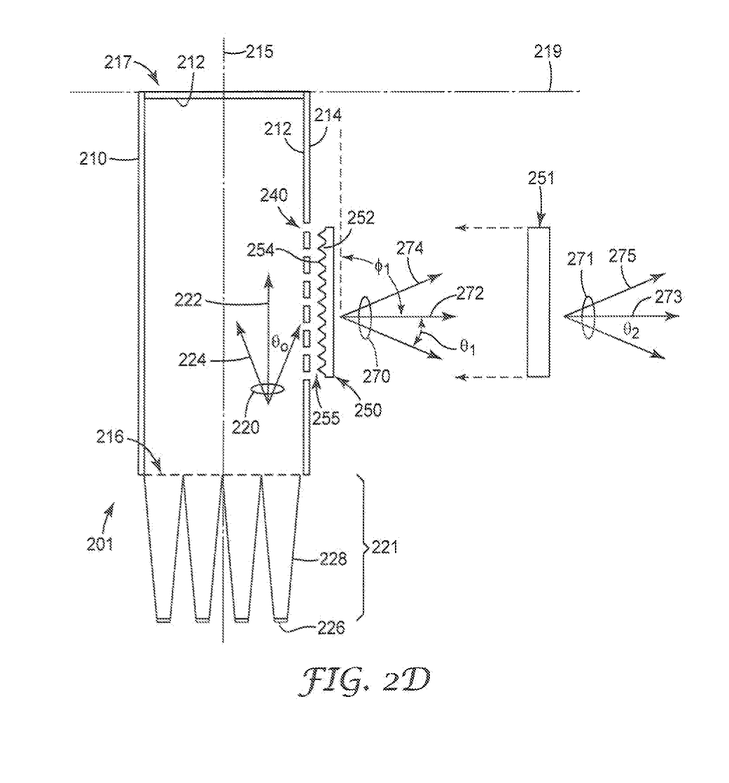

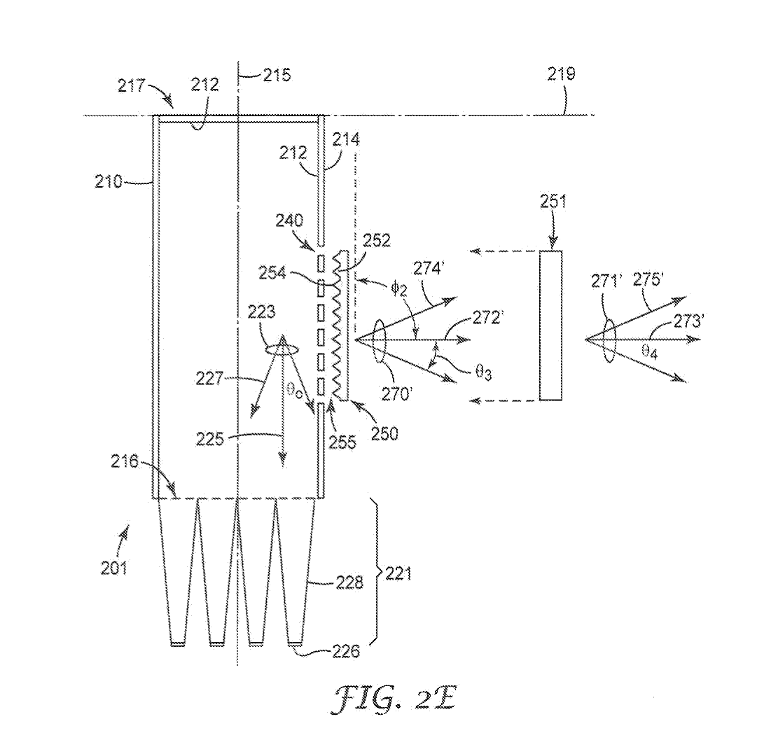

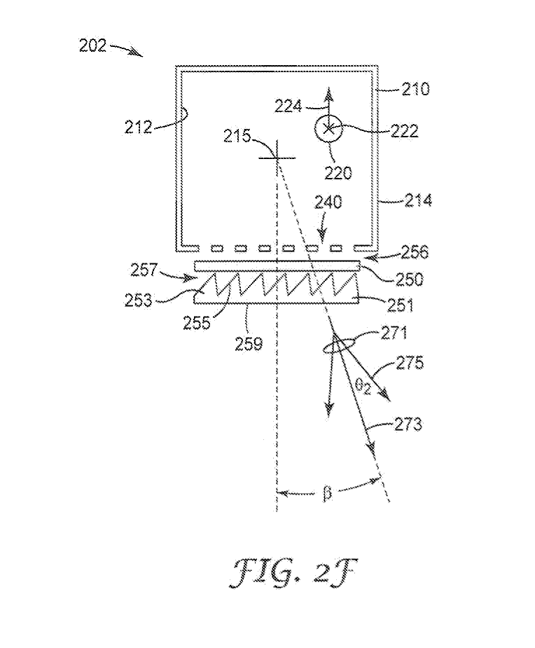

FIG. 2A shows an exploded perspective schematic view of a lighting element 200 that includes a rectangular light duct extractor, according to one aspect of the disclosure. Each of the elements 210-230 shown in FIG. 2A correspond to like-numbered elements 110-130 shown in FIG. 1, which have been described previously. For example, light duct 210 shown in FIG. 2A corresponds to light duct 110 shown in FIG. 1, and so on. Lighting element 200 includes a light duct 210 having a longitudinal axis 215, a reflective surface 212 surrounding a cavity, a light input end 216, and an opposing end 217. A partially collimated light beam 220 having a central light ray 222 and boundary light rays 224 disposed within an input collimation half-angle θ₀ of the longitudinal axis 215 can be efficiently transported along the light duct 210. A portion of the partially collimated light beam 220 can leave the light duct 210 through a plurality of voids 240 disposed in the reflective surface 212 in a light output surface 230 where light is extracted. A asymmetric turning film 250 having a plurality of parallel ridged microstructures 252 is positioned adjacent the light output surface 230 such that a vertex 254 corresponding to each of the parallel ridged microstructures 252 is positioned proximate an exterior surface 214 of light duct 210. The asymmetric turning film 250 can intercept light rays exiting the cavity through one of the plurality of voids 240.

An optional steering film 251 having a plurality of parallel ridges 253 each with a steering vertex 255, is positioned adjacent the asymmetric turning film 250 and opposite the light output surface 230 of the light duct 210. Each of the plurality of parallel ridges 253 positioned parallel to the longitudinal axis 215 of light duct 210, such that each of the plurality of parallel ridges 253 can refract light rays exiting the asymmetric turning film 250 into a direction perpendicular to the longitudinal axis 215, such that a light ray that exits the cavity through the light output surface 230 is redirected into a first direction disposed within a first plane perpendicular to the light duct cross-section by the asymmetric turning film, and into a second direction within a second plane parallel to the light duct cross section by the steering film, as described elsewhere.

In one particular embodiment, each of the plurality of voids 240 can be physical apertures, such as holes that pass either completely through, or through only a portion of the thickness of the reflective surface 212. In one particular embodiment, each of the plurality of voids 240 can instead be solid clear or transparent regions such as windows, formed in the reflective surface 212 that do not substantially reflect light. In either case, the plurality of voids 240 designates a region of the reflective surface 212 where light can pass through, rather than reflect from the surface. The voids can have any suitable shape, either regular or irregular, and can include curved shapes such as arcs, circles, ellipses, ovals, and the like; polygonal shapes such as triangles, rectangles, pentagons, and the like; irregular shapes including X-shapes, zig-zags, stripes, slashes, stars, and the like; and combinations thereof.

The plurality of voids 240 can be made to have any desired percent open (i.e., non-reflective) area from about 5% to about 95%. In one particular embodiment, the percent open area ranges from about 5% to about 70%, or from about 10% to about 50%. In some cases, the percent open area can be about 70%. The size range of the individual voids can also vary, in one particular embodiment, the voids can range in major dimension from about 0.5 mm to about 5 mm, or from about 0 5 mm to about 3 mm, or from about 1 mm to about 2 mm.

In some cases, the voids can be uniformly distributed across the light output surface 230 and can have a uniform size. However, in some cases, the voids can have different sizes and distributions across the light output surface 230, and can result in a variable areal distribution of void (i.e., open) across the output region. The plurality of voids 240 can optionally include switchable elements (not shown) that can be used to regulate the output of light from the light duct by changing the void open area gradually from fully closed to fully open, such as those described in, for example, co-pending U.S. Patent Publication No. US2012-0057350 entitled, SWITCHABLE LIGHT-DUCT EXTRACTION.

The voids can be physical apertures that may be formed by any suitable technique including, for example, die cut, laser cut, molded, formed, and the like. The voids can instead be transparent windows that can be provided of many different materials or constructions. The areas can be made of multilayer optical film or any other transmissive or partially transmissive materials. One way to allow for light transmission through the areas is to provide areas in optical surface which are partially reflective and partially transmissive. Partial reflectivity can be imparted to multilayer optical films in areas by a variety of techniques.

In one aspect, areas may comprise multi-layered optical film which is uniaxially stretched to allow transmission of light having one plane of polarization while reflecting light having a plane of polarization orthogonal to the transmitted light, such as described, for example, in U.S. Pat. No. 7,147,903 (Ouderkirk et al.), entitled “High Efficiency Optical Devices”. In another aspect, areas may comprise multi-layered optical film which has been distorted in selected regions, to convert a reflective film into a light transmissive film. Such distortions can be effected, for example, by heating portions of the film to reduce the layered structure of the film, as described, for example, in PCT Publication No. WO2010075357 (Merrill et al.), entitled “internally Patterned Multilayer Optical Films using Spatially Selective Birefringence Reduction”.

The selective birefringence reduction can be performed by the judicious delivery of an appropriate amount of energy to the second zone so as to selectively heat at least some of the interior layers therein to a temperature high enough to produce a relaxation in the material that reduces or eliminates a preexisting optical birefringence, but low enough to maintain the physical integrity of the layer structure within the film. The reduction in birefringence may be partial or it may be complete, in which case interior layers that are birefringent in the first zone are rendered optically isotropic in the second zone. In exemplary embodiments, the selective heating is achieved at least in part by selective delivery of light or other radiant energy to the second zone of the film.

In one particular embodiment, the asymmetric turning film 250 can be a microstructured film such as, for example, Vikuiti™ Image Directing Films, available from 3M Company. The asymmetric turning film 250 can include one plurality of parallel ridged microstructure shapes, or more than one different parallel ridged microstructure shapes, such as having a variety of included angles used to direct light in different directions, as described elsewhere.

FIG. 2B shows a perspective schematic view of the lighting element 200 of FIG. 2A, according to one aspect of the disclosure. The perspective schematic view shown in FIG. 2B can be used to further describe aspects of the lighting element 200. Each of the elements 210-250 shown in FIG. 2B correspond to like-numbered elements 210-250 shown in FIG. 2A, which have been described previously. For example, light duct 210 shown in FIG. 2B corresponds to light duct 210 shown in FIG. 2A, and so on. In FIG. 2B, a cross-section 218 of light duct 210 including the exterior 214 is perpendicular to the longitudinal axis 215, and a first plane 260 passing through the longitudinal axis 215 and the asymmetric turning film 250 is perpendicular to the cross-section 218. In a similar manner, a second plane 265 is parallel to the cross-section 218 and perpendicular to both the first plane 260 and the asymmetric turning film 250. As described herein, cross-section 218 generally includes a light output surface 230 disposed on a planar surface; in some cases, the light output surface 230 can include different planar segments of a planar-surface duct. Examples of some typical cross-section figures include triangles, squares, rectangles, pentagons, or other polygonal shapes.

The lighting element 200 further includes an optional steering film 251 disposed adjacent the asymmetric turning film 250, such that the asymmetric turning film 250 is positioned between the optional steering film 251 and the exterior 214 of the light duct 210. The optional steering film 251 is disposed to intercept light exiting from the asymmetric turning film 250 and provide angular spread of the light in a radial direction (i.e., in directions within second plane 265), as described elsewhere.

The half angle of light rays exiting the light duct in the second plane 265 is comparable to the half angle of collimation within the light duct. The half angle of light rays exiting the light duct in the first plane 260 is approximately one-half the half angle within the light duct; i.e., only half of the directions immediately interior to the ESR have the opportunity to escape through a perforation. Thus, the precision of directing the light in a desired direction increases as the half angle within the light duct decreases.

Light rays that pass through a perforation encounter the prismatic asymmetric turning film 250. The light rays strike the prisms of the asymmetric turning film 250 in a direction substantially parallel to the plane of the asymmetric turning film 250 and perpendicular to the axes of the prisms—the divergence of their incidence from this norm is dictated by the collimation within the light duct. A majority of these rays enter the film by refracting through the first prism face encountered, then undergoing total internal reflection (TIR) from the opposing face, and finally refract through the opposing planar surface of the film, as described elsewhere. The net change in direction along the axis of the light duct can be readily calculated by using the index of refraction of the asymmetric turning film prism material and the included angle of the prisms, as described elsewhere. Since most rays are transmitted, very little light is returned to the light duct, facilitating the maintenance of collimation within the light duct.

Light rays that pass through the asymmetric turning film 250 can next encounter an optional decollimation film or plate (also referred to as the optional steering film 251), as described elsewhere. The rays that encounter the optional steering film 251 strike the structured surface of this film, are refracted into directions determined by the local slope of the structure, and pass through the opposing planar surface. The net change in direction perpendicular to the longitudinal axis is determined by the index of refraction and the distribution of surface slopes of the structure, as described elsewhere. The optional steering film structure can be a smooth curved surface such as a cylindrical or aspheric ridge-like lens, or can be piecewise planar such as to approximate a smooth curved lens structure, or it can be planar. In general, the optional steering film structures are selected to yield a specified distribution of illuminance upon target surfaces occurring at distances from the light duct large compared to the cross-duct dimension of the emissive surface. In one particular embodiment, the steering film can have a “sawtooth” shaped structure that steers light from the bollard illuminator at an angle to illuminate the crosswalk from the curb of the street. The structure of this optional steering film can eliminate the need to adjust the bollard illuminator at an angle to the crosswalk, which can add to the costs and complexity of installation. Again, since most rays are transmitted through the steering film, very little light is returned to the light duct, preserving the collimation within the light duct.

In many cases the asymmetric turning film and steering film, if present, may use a transparent support plate or tube surrounding the light duct (depending on the light duct configuration), such as an enclosure surrounding a bollard luminaire for use in pedestrian crosswalks. In one particular embodiment, the transparent support can be laminated to the outermost film component, and can include an anti-reflective coating on the outermost surface. Both lamination and AR coats increase transmission through and decrease reflection from the outermost component, increasing the overall efficiency of the lighting system, and better preserving the collimation within the light duct.

FIG. 2C shows a schematic cross sectional side view near the light output surface 230 of the lighting element 200 of FIGS. 2A and 2B, according to one aspect of the disclosure. Each of the elements 215-250 shown in FIG. 2C correspond to like-numbered elements 215-250 shown in FIG. 2B, which have been described previously. For example, longitudinal axis 215 shown in FIG. 2C corresponds to longitudinal axis 215 shown in FIG. 2A, and so on. Further, as shown in FIG. 1, the bollard luminaire 100 has a longitudinal axis 115 generally aligned vertically, and therefore generally the longitudinal axis 215 is in a vertical orientation.

A partially collimated light beam 220 having a central light ray 222 and boundary light rays 224 disposed within an input collimation half-angle θ₀ of the longitudinal axis 215 can propagate down the lighting element 200 of FIGS. 2A and 2B. A portion of the partially collimated light beam 220 can leave the lighting element 200 through a plurality of voids 240 disposed in the reflective surface 212 in a light output surface 230 where light is extracted. An asymmetric turning film 250 having a plurality of parallel ridged microstructures 252 and an opposing planar surface 259, is positioned adjacent the light output surface 230 such that a vertex 254 corresponding to each of the parallel ridged microstructures 252 is positioned proximate the plurality of voids 240. The asymmetric turning film 250 is positioned to intercept and redirect light rays exiting through one of the plurality of voids 240.

The vertex 254 corresponding to each of the parallel ridged microstructures 252 has a prism angle (α1+α2) between a first planar face 256 and a second planar face 258 of the parallel ridged microstructures 252. In some cases, the prism angle (α1+α2) can vary from about 30 degrees to about 120 degrees, or from about 45 degrees to about 90 degrees, or from about 55 degrees to about 75 degrees, to redirect light incident on each of the parallel ridged microstructures 252. In one particular embodiment, the prism angle (α1+α2) is about 72 degrees and the partially collimated light beam 220 that exits through the plurality of voids 240 is redirected by the asymmetric turning film 250 away from the longitudinal axis 215.

The prism angle (α1+α2) includes a bisector 257 that is perpendicular to both the longitudinal axis 215 and the opposing second planar surface 259 of the asymmetric turning film 250. The bisector 257 divides the prism angle (α1+α2) into a first vertex angle al between the second surface 258 and the bisector 257, and a second vertex angle α2 between the first surface 256 and the bisector 257. In one particular embodiment, in order to direct the light so that glare to the pedestrian and driver are reduced, the first vertex angle al and the second vertex angle α2 are different angles. In some cases, the second vertex angle α2 (closer to the light input end 216 shown in FIGS. 2A and 2B where the partially collimated light beam 220 originates from), is larger than the first vertex angle al (closer to the opposing end 217 shown in FIGS. 2A and 2B).

A first extracted light ray 229 travelling generally from the light input end 216 (shown in FIGS. 2A and 2B) intersects first surface 256, refracts as it enters asymmetric turning film 250, reflects by total internal reflection (TIR) from second surface 258, and refracts again as it exits asymmetric turning film 250 through opposing planar surface 259. In a similar manner, a second extracted light ray (not shown), travelling generally from the opposing end 217 (shown in FIGS. 2A and 2B) intersects second surface 258, refracts as it enters asymmetric turning film 250, reflects by TIR from first surface 256, and refracts again as it exits asymmetric turning film 250 through opposing planar surface 259.

The redirected portion of the partially collimated light beam 220 exits as a partially collimated output light beam 270 having a central light ray 272 and boundary light rays 274 disposed within an output collimation half-angle θ₁ and where the central light ray 272 is directed at a longitudinal angle φ₁ from the longitudinal axis 215. In some cases, the input collimation half-angle θ₀ and the output collimation half angle θ₁ can be the same, and the collimation of light is retained. In one particular embodiment, the longitudinal angle φ1 is greater than about 90 degrees, such that the majority of the light generally remains below the horizontal plane and is prevented from producing glare that may impact the vision of either the pedestrian or the driver. The longitudinal angle φ₁ is such that the central light ray 272 does not cross the bisector 257, and therefore also does not cross a plane passing through the opposing end 217 of the lighting element 200. The longitudinal angle φ₁ from the longitudinal axis can vary from greater than about 90 degrees to about 135 degrees, or from greater than about 95 degrees to about 120 degrees, or from greater than about 90 degrees to about 105 degrees, depending on the included angle of the microstructures.

FIG. 2D shows a cross-sectional schematic side view of a luminaire 201, such as a bollard luminaire, according to one aspect of the disclosure. Luminaire 201 can include a cross-section of the lighting element 200 of FIG. 2B, along the first plane 260. Each of the elements 210-250 shown in FIG. 2C correspond to like-numbered elements 210-250 shown in FIG. 2B, which have been described previously. For example, light duct 210 shown in FIG. 2D corresponds to light duct 210 shown in FIG. 2B, and so on. Luminaire 201 includes a light duct 210 and a light source 221 disposed to inject a light beam into the light duct 210 through a light input end 216. Light source 221 includes one or more lighting elements 226 and collimation horns 228 that serve to partially collimate the light, as described elsewhere. In one particular embodiment, lighting elements 226 can be LED sources. Luminaire 201 includes the light duct 210 having a longitudinal axis 215, a reflective surface 212 surrounding a cavity, the light input end 216 and an opposing end 217. In some cases, the opposing end 217 can be a reflective end and include reflective surface 212. In some cases, the opposing end 217 can instead include a second light source (not shown), disposed to inject a light beam into the opposing end 217 toward the light input end 216.

A partially collimated light beam 220 having a central light ray 222 and boundary light rays 224 disposed within an input collimation half-angle θ₀ of the longitudinal axis 215 can be efficiently transported along the light duct 210 from light input end 216 toward opposing end 217. A portion of the partially collimated light beam 220 can leave the light duct 210 through a plurality of voids 240 disposed in the reflective surface 212 in a light output surface 230 where light is extracted. An asymmetric turning film 250 having a plurality of parallel ridged microstructures 252 is positioned adjacent the light output surface 230 such that a vertex 254 corresponding to each of the parallel ridged microstructures 252 is positioned proximate an exterior surface 214 of light duct 210. In one particular embodiment, each vertex 254 can be immediately adjacent the exterior surface 214; however, in some cases, each vertex 254 can instead be separated from the exterior surface 214 by a separation distance 255. The asymmetric turning film 250 is positioned to intercept and redirect light rays exiting the cavity through one of the plurality of voids 240, and has been described elsewhere, for example with reference to FIG. 2C.

The redirected portion of the partially collimated light beam 220 exits as a partially collimated output light beam 270 having a central light ray 272 and boundary light rays 274 disposed within an output collimation half-angle θ₁ and where the central light ray 272 is directed at a longitudinal angle φ₁ from the longitudinal axis 215. In some cases, the input collimation half-angle θ₀ and the output collimation half angle θ₁ can be the same, and the collimation of light is retained. In one particular embodiment, the longitudinal angle φ₁ is greater than about 90 degrees, such that the majority of the light generally remains below the horizontal plane and is prevented from producing glare that may impact the vision of either the pedestrian or the driver. The longitudinal angle φ₁ is such that the central light ray 272 does not cross the bisector 257 shown in FIG. 2C, and therefore also does not cross a plane passing through the opposing end 217 of the lighting element 200. The longitudinal angle φ₁ from the longitudinal axis can vary from greater than about 90 degrees to about 135 degrees, or from greater than about 95 degrees to about 120 degrees, or from greater than about 90 degrees to about 105 degrees, depending on the included angle of the microstructures.

An optional steering film 251 is positioned adjacent the asymmetric turning film 250 and opposite the light output surface 230 of the light duct 210 to intercept and refract the partially collimated output light beam 270. The partially collimated output light beam 270 exits the optional steering film 251 as a partially collimated steered light beam 271 having a central steered light ray 273 and boundary steered light rays 275 disposed within a steered collimation half-angle θ₂, as described elsewhere.

FIG. 2E shows a cross-sectional schematic side view of the luminaire 201 shown in FIG. 2D, according to one aspect of the disclosure. Each of the elements 210-250 shown in FIG. 2E correspond to like-numbered elements 210-250 shown in FIG. 2D, which have been described previously. For example, light duct 210 shown in FIG. 2E corresponds to light duct 210 shown in FIG. 2D, and so on. In FIG. 2E, the portion of the partially collimated light beam 220 that reaches the opposing end 217 having reflective surface 212, is reflected back toward the light input end 216 as a partially collimated second light beam 223 having a central second light ray 225 and boundary second light rays 227 disposed within the input collimation half-angle θ₀ of the longitudinal axis 215.

A portion of the partially collimated second light beam 223 can leave the light duct 210 through the plurality of voids 240 disposed in the reflective surface 212 in the light output surface 230 where light is extracted. The redirected portion of the partially collimated second light beam 223 exits as a partially collimated output second light beam 270′ having a central second light ray 272′ and boundary second light rays 274′ disposed within an output collimation half-angle θ₃ and where the central second light ray 272′ is directed at a longitudinal angle φ2 from the longitudinal axis 215. In some cases, the input collimation half-angle θ₀ and the output collimation half angle θ₃ can be the same, and the collimation of light is retained. In one particular embodiment, the longitudinal angle φ2 is greater than about 90 degrees, such that the majority of the light generally remains below the horizontal plane and is prevented from producing glare that may impact the vision of either the pedestrian or the driver. The longitudinal angle φ2 is such that the central second light ray 272′ does not cross the bisector 257 shown in FIG. 2C, and therefore also does not cross a plane passing through the opposing end 217 of the lighting element 200. The longitudinal angle φ2 from the longitudinal axis can vary from greater than about 90 degrees to about 135 degrees, or from greater than about 95 degrees to about 120 degrees, or from greater than about 90 degrees to about 105 degrees, depending on the included angle of the microstructures.

An optional steering film 251 is positioned adjacent the asymmetric turning film 250 and opposite the light output surface 230 of the light duct 210 to intercept and refract the partially collimated output light beam 270′. The partially collimated output light beam 270′ exits the optional steering film 251 as a partially collimated steered light beam 271′ having a central steered light ray 273′ and boundary steered light rays 275′ disposed within a steered collimation half-angle θ₄, as described elsewhere.

FIG. 2F shows a cross-sectional schematic view of a luminaire 202, such as a bollard luminaire, according to one aspect of the disclosure. Luminaire 202 can be a cross-section of the lighting element 200 of FIG. 2B, along the second plane 265. Each of the elements 210-250 shown in FIG. 2F correspond to like-numbered elements 210-250 shown in FIG. 2B, which have been described previously. For example, longitudinal axis 215 shown in FIG. 2F corresponds to longitudinal axis 215 shown in FIG. 2B, and so on.

Luminaire 202 includes a light duct 210 having a longitudinal axis 215 and a reflective surface 212 surrounding a cavity. A partially collimated light beam 220 having a central light ray 222 and boundary light rays 224 disposed within an input collimation half-angle θ₀ of the longitudinal axis 215 can be efficiently transported along the light duct 210, shown directed into the paper as shown in FIG. 2F. A portion of the partially collimated light beam 220 can leave the light duct 210 through a plurality of voids 240 disposed in the reflective surface 212 where light is extracted. An asymmetric turning film 250 is positioned adjacent the plurality of voids 240 as described with reference to FIG. 2A-2D. The asymmetric turning film 250 is positioned to intercept and redirect light rays exiting the cavity through one of the plurality of voids 240, such that the redirection of light rays occurs in first plane 260 that passes through longitudinal axis 215. In one particular embodiment, the asymmetric turning film 250 does not influence the path of light rays within the second plane 265 perpendicular to the longitudinal axis.

The path of light rays within the second plane 265, i.e. in radial directions about the longitudinal axis 215, is influenced by an optional steering film 251. The optional steering film 251 includes a planar output surface 259 and plurality of parallel ridges 253 each with a steering vertex 255, positioned adjacent the asymmetric turning film 250 and opposite the light output surface 230 of the light duct 210. In one particular embodiment, each steering vertex 255 can be immediately adjacent the asymmetric turning film 250; however, in some cases, each steering vertex 255 can instead be separated from the asymmetric turning film 250 by a separation distance 257.

Each of the plurality of parallel ridges 253 can be positioned parallel to the longitudinal axis 215 of light duct 210, such that each of the plurality of parallel ridges 253 can refract light rays exiting the asymmetric turning film 250 into a direction perpendicular to the longitudinal axis 215, such that a light ray that exits the cavity through the light output surface 230 is redirected into a first direction disposed within a first plane perpendicular to the light duct cross-section by the asymmetric turning film, and into a second direction within a second plane parallel to the light duct cross section by the optional steering film.

In one particular embodiment, the partially collimated output light beam 270 from the asymmetric turning film enters the optional steering film 251 and then exits as a partially collimated steered light beam 271 having a central steered light ray 273 and boundary steered light rays 275 disposed within a steered collimation half-angle θ₂. A first component of the central steered light ray 273 is directed within the second plane 265 in a second direction at a radial angle β from the first plane 260. A second component of the central steered light ray 273 is directed within the first plane 260 in a first direction at a longitudinal angle φ from the longitudinal axis. In some cases, each of the input collimation half-angle θ₀, the output collimation half angle θ₁, and the steered collimation half-angle θ₂ can be the same, and the collimation of light is retained. The radial angle β around the longitudinal axis can vary from about 0 degrees to about ±45 degrees, or from about 0 degrees to about ±30 degrees, or from about 0 degrees to about ±10 degrees, of the light duct 210. As shown in FIG. 1, the radial angle β around the longitudinal axis 115 can be used to direct the light to the crosswalk without changing the angle that the bollard luminaire 100 makes with the curb 20, so that installation of the bollard luminaire 100 can be simplified.

Generally, the half angle in the along-duct direction of the emission through any lighting element of the form depicted in FIGS. 2A-2F is approximately one-half the half angle of the collimation within the light duct, since typically only one-half of the rays within the cone of rays striking the void will exit the light duct. In some cases, it can be desirable to increase the half angle in the along-duct direction without altering the angular distribution emitted in the cross-duct direction. Increasing the half angle in the along-duct direction will elongate the segment of the emissive surface which makes a substantive contribution to the illuminance at any point on a target surface. It generally is not acceptable to increase the half angle along the light duct by simply increasing the half angle within the light duct, as this would alter the cross-duct distribution and ultimately degrade the precision of cross-duct control.

For example, the along-duct distribution is centered approximately about normal for index-1.6, 69-degree turning prisms. It is centered about a direction with a small backward component (relative to the sense of propagation within the light duct) for included angles less than 69 degrees, and about a direction with a forward component for included angles greater than 69 degrees. Thus, a asymmetric turning film composed of prisms with a plurality of included angles, including some less than 69 degrees and some greater than 69 degrees, can produce an along-duct distribution approximately centered about normal, but possessing a larger along-duct half angle than a film composed entirely of 69-degree prisms.

### Examples

A bollard luminaire similar to that shown in FIG. 2D was designed to provide vertical illumination of pedestrians in crosswalks as shown in FIG. 1. The bollard luminaire enclosure measured 4 feet (1.22 m) in height and had a light output region that measured 3 feet (91 cm) in height by 6 inches (15 cm) in width located at the top of the bollard luminaire enclosure. The crosswalk length “L” was 24 feet (7.32 m), the illumination height “H” was 4 feet (1.22 m), the illumination width “W” was 8 feet (2.44 m), and the curb (20) height was 1 foot (61 cm). The light source measured 8 inches (20 cm) in height and 2 inches (5 cm) in width, and held three collimating horns, each collimating horn measuring 8 inches (20 cm) long, 2 inches (5 cm) square at the outlet aperture, and ⅓ of an inch (0.85 cm) square at the inlet aperture, resulting in a collimation half-angle of about 9.6 degrees.

Each horn used a single LED located at the inlet aperture, and the performance was simulated using a Cree XT-E white LED, rated at 130 lumens/watt (available from Cree Inc., Morrisville, N.C.). The light duct cavity was hollow and lined with ESR, and the light output region had uniform perforations in the ESR, providing a 70% open area. Light exiting the perforations encountered an asymmetric-prism asymmetric turning film, a steering film, and a rigid transparent support member (polycarbonate plate). The asymmetric-prism turning film was required to turn both upward- and downward-directed light passing through the ESR perforations to an angle somewhat below horizontal, and included a 37 degrees vertex angle proximate the light source, and a 35 degree vertex angle proximate the opposing end, as described in FIG. 2C. The steering film was designed to provide an approximately 9.5 degree steering angle β as shown in FIG. 2F, so that the crosswalk was illuminated without having to rotate the bollard luminaire relative to the crosswalk.

A simulation was run to determine the light flux using conventional ray-tracing software. The simulation considered the light output area divided into three equal portions, and considered light propagating from the light source to the opposing end (segment 1, 2, and 3, in order from the light source) and the light having reflected from the opposing end and propagating back toward the light source (segment 4, 5, 6 in order from the opposing end). Results of the simulation are shown in Table 1.

TABLE 1
Extracted and Propagating Light Flux from Luminaire

| | Incident Flux | Extracted Flux | Total Extracted Flux |
|---|---|---|---|
| | Normalized to | Normalized to | Normalized to |
| Segment | Segment 1 | Segment 1 Input | Segment 1 Input |
| 1 | 1.000 | 0.176 | 0.224 (Segment 1 + 6) |
| 2 | 0.819 | 0.165 | 0.224 (Segment 2 + 5) |
| 3 | 0.652 | 0.103 | 0.185 (Segment 3 + 4) |
| 4 | 0.548 | 0.082 | |
| 5 | 0.466 | 0.059 | |
| 6 | 0.407 | 0.048 | |
| Residual | 0.361 | | |
| Back to LED | | | |

The light flux on the crosswalk from a pair of luminaires positioned on the same curb (20) as shown in FIG. 1, was simulated using the above inputs, to provide values for the vertical luminance, pedestrian glare, and driver glare. About 1 foot-candle illumination was produced in the illumination region throughout the crosswalk for each of the 12 LEDs being operated at the 130 lumen/watt level (about 0.4 watts/LED), which resulted in about 5 watts total for the four luminaires shown in FIG. 1. Each LED can be reliably operated at about 2 watts/LED, resulting in a minimum vertical illuminance was about 5 foot-candles at this level. The uniformity within the illumination region was about 4:1, so the maximum vertical illuminance was about 4 foot-candles at 0.4 watts/LED, and about 20 foot-candles at 2 watts/LED. The pedestrian glare was calculated to be less than 1000 nits, and considered the total brightness at about 18 inches (45.7 cm) above the illumination region height “H” of 4 feet (1.22 m)—considered to be average adult pedestrian eye-level. The maximum brightness perceived by a child (i.e., within the illumination region) was about 17,000 nits. The driver glare, for approach from any direction perpendicular to the crosswalk, was calculated to be about 65 nits.

Following are a list of embodiments of the present disclosure.

Item 1 is a luminaire, comprising: a light duct having a longitudinal axis, light input end, an opposing end, and a reflective interior surface surrounding a cavity; a light output region including a plurality of voids disposed in the reflective interior surface, whereby light can exit the cavity; an asymmetric turning film, comprising: a first surface including parallel prismatic microstructures, each having a vertex adjacent the light output region and aligned perpendicular to the longitudinal axis; and an opposing second planar surface, wherein each vertex includes a prism angle having a bisector that is perpendicular to the longitudinal axis and the opposing second planar surface, the bisector dividing the prism angle into a first vertex angle proximate the light input end and a different second vertex angle proximate the opposing end.

Item 2 is the luminaire of item 1, wherein the first vertex angle is larger than the second vertex angle.

Item 3 is the luminaire of item 1 or item 2, further comprising a light source capable of injecting light into the light duct through the light input end, the opposing end, or both the light input end and the opposing end.

Item 4 is the luminaire of item 1 to item 3, further comprising a light source capable of injecting light into the light duct through the light input end, wherein the opposing end comprises a reflective surface capable of reflecting incident light toward the light input end.

Item 5 is the luminaire of item 1 to item 4, wherein a light ray that intersects the plurality of voids exits the cavity and is turned by the asymmetric turning film within a first plane parallel to the longitudinal axis to an output angle, the output angle being within an angular spread of a central output direction, wherein the central output direction does not intersect a second plane perpendicular to the longitudinal axis and passing through the opposing end.

Item 6 is the luminaire of item 1 to item 5, further comprising a steering film adjacent the opposing planar surface of the asymmetric turning film, the steering film having a plurality of parallel ridges parallel to the longitudinal axis configured to refract a light ray exiting the asymmetric turning film into a steered direction within a third plane perpendicular to the longitudinal axis.

Item 7 is the luminaire of item 1 to item 6, wherein the plurality of voids includes an areal density that varies along the longitudinal axis.

Item 8 is the luminaire of item 1 to item 7, wherein the output surface is a planar surface or a curved surface.

Item 9 is a luminaire, comprising: a light duct having a longitudinal axis, light input end, an opposing end, and a reflective interior surface surrounding a cavity; a light output region including a plurality of voids disposed in the reflective interior surface, whereby light can exit the cavity; an asymmetric turning film, comprising: a first surface including parallel prismatic microstructures, each having a vertex adjacent the light output region and aligned perpendicular to the longitudinal axis; an opposing second planar surface; and a light source disposed to inject a light beam into the light duct through the light input end, wherein each vertex includes a prism angle having a bisector that is perpendicular to the longitudinal axis and the opposing second planar surface, the bisector dividing the prism angle into a first vertex angle proximate the light input end and a different second vertex angle proximate the opposing end.

Item 10 is the luminaire of item 9, wherein the first vertex angle is larger than the second vertex angle.

Item 11 is the luminaire of item 9 or item 10, wherein the opposing end comprises a reflective surface capable of reflecting light from the light source back toward the light input end, or a second light source capable of injecting a second light beam into the light duct.

Item 12 is the luminaire of item 9 to item 11, wherein a first light ray having a first propagation direction toward the opposing end that intersects the plurality of voids, exits the cavity, and is turned by the asymmetric turning film within a first angular spread from a plane perpendicular to the longitudinal axis, and wherein a second light ray having a second propagation direction toward the light input end intersects the plurality of voids, exits the cavity, and is turned by the asymmetric turning film within a second angular spread from the plane perpendicular to the longitudinal axis.

Item 13 is the luminaire of item 12, wherein the first angular spread and the second angular spread each comprise a central output direction that does not intersect a second plane perpendicular to the longitudinal axis and passing through the opposing end.

Item 14 is the luminaire of item 9to item 13, further comprising a steering film adjacent the opposing planar surface of the asymmetric turning film, the steering film having a plurality of parallel ridges parallel to the longitudinal axis configured to refract a light ray from the asymmetric turning film into a steered direction within a third plane perpendicular to the longitudinal axis.

Item 15 is the luminaire of item 9 to item 14, wherein the light source comprises at least one collimating horn and a light emitting diode (LED) disposed to inject light into the collimating horn.

Item 16 is the luminaire of item 9 to item 15, wherein the light beam includes a collimation half-angle no greater than about 10 degrees.

Item 17 is the luminaire of item 12, wherein the first angular spread and the second angular spread are each less than about 10 degrees.

Item 18 is the luminaire of item 9 to item 17, wherein the first vertex angle is about 37 degrees, and the second vertex angle is about 35 degrees.

Item 19 is the luminaire of item 9 to item 18, further comprising a battery to power the light source.

Item 20 is the luminaire of item 9 to item 19, further comprising a solar cell capable of charging the battery.

Item 21 is the luminaire of item 9 to item 20, wherein the light source is controlled by an attached switch, a wired connection, a wireless connection, a timer, or a combination thereof.

Item 22 is the luminaire of item 9 to item 21, further comprising a housing that at least partially encloses the light duct, the light output region, the asymmetric turning film, and the light source.

Item 23 is a method of illuminating a pedestrian cross-walk, comprising: positioning at least one luminaire of claim10 on a roadway adjacent a pedestrian cross-walk such that the longitudinal axis is positioned vertically; and energizing the light source such that the cross-walk is illuminated while reducing illumination of surrounding areas.

Unless otherwise indicated, all numbers expressing feature sizes, amounts, and physical properties used in the specification and claims are to be understood as being modified by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

All references and publications cited herein are expressly incorporated herein by reference in their entirety into this disclosure, except to the extent they may directly contradict this disclosure. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

1. A luminaire, comprising:
a light duct having a longitudinal axis, light input end, an opposing end, and a reflective interior surface surrounding a cavity;
a light output region including a plurality of voids disposed in the reflective interior surface, whereby light can exit the cavity;
an asymmetric turning film, comprising:
a first surface including parallel prismatic microstructures, each having a vertex adjacent the light output region and aligned perpendicular to the longitudinal axis; and
an opposing second planar surface,
wherein each vertex includes a prism angle having a bisector that is perpendicular to the longitudinal axis and the opposing second planar surface, the bisector dividing the prism angle into a first vertex angle proximate the light input end and a different second vertex angle proximate the opposing end.

2. The luminaire of claim 1, wherein the first vertex angle is larger than the second vertex angle.

3. The luminaire of claim 1, further comprising a light source capable of injecting light into the light duct through the light input end, the opposing end, or both the light input end and the opposing end.

4. The luminaire of claim 1, further comprising a light source capable of injecting light into the light duct through the light input end, wherein the opposing end comprises a reflective surface capable of reflecting incident light toward the light input end.

5. The luminaire of claim 1, wherein a light ray that intersects the plurality of voids exits the cavity and is turned by the asymmetric turning film within a first plane parallel to the longitudinal axis to an output angle, the output angle being within an angular spread of a central output direction, wherein the central output direction does not intersect a second plane perpendicular to the longitudinal axis and passing through the opposing end.

6. The luminaire of claim 1, further comprising a steering film adjacent the opposing planar surface of the asymmetric turning film, the steering film having a plurality of parallel ridges parallel to the longitudinal axis configured to refract a light ray exiting the asymmetric turning film into a steered direction within a third plane perpendicular to the longitudinal axis.

7. The luminaire of claim 1, wherein the plurality of voids includes an areal density that varies along the longitudinal axis.

8. The luminaire of claim 1, wherein the output surface is a planar surface or a curved surface.

9. A luminaire, comprising:
a light duct having a longitudinal axis, light input end, an opposing end, and a reflective interior surface surrounding a cavity;
a light output region including a plurality of voids disposed in the reflective interior surface, whereby light can exit the cavity;
an asymmetric turning film, comprising:
a first surface including parallel prismatic microstructures, each having a vertex adjacent the light output region and aligned perpendicular to the longitudinal axis;
an opposing second planar surface; and
a light source disposed to inject a light beam into the light duct through the light input end,
wherein each vertex includes a prism angle having a bisector that is perpendicular to the longitudinal axis and the opposing second planar surface, the bisector dividing the prism angle into a first vertex angle proximate the light input end and a different second vertex angle proximate the opposing end.

10. The luminaire of claim 9, wherein the first vertex angle is larger than the second vertex angle.

11. The luminaire of claim 9, wherein the opposing end comprises a reflective surface capable of reflecting light from the light source back toward the light input end, or a second light source capable of injecting a second light beam into the light duct.

12. The luminaire of claim 9, wherein a first light ray having a first propagation direction toward the opposing end that intersects the plurality of voids, exits the cavity, and is turned by the asymmetric turning film within a first angular spread from a plane perpendicular to the longitudinal axis, and wherein a second light ray having a second propagation direction toward the light input end intersects the plurality of voids, exits the cavity, and is turned by the asymmetric turning film within a second angular spread from the plane perpendicular to the longitudinal axis.

13. The luminaire of claim 12, wherein the first angular spread and the second angular spread each comprise a central output direction that does not intersect a second plane perpendicular to the longitudinal axis and passing through the opposing end.

14. The luminaire of claim 9, further comprising a steering film adjacent the opposing planar surface of the asymmetric turning film, the steering film having a plurality of parallel ridges parallel to the longitudinal axis configured to refract a light ray from the asymmetric turning film into a steered direction within a third plane perpendicular to the longitudinal axis.

15. The luminaire of claim 9, wherein the light source comprises at least one collimating horn and a light emitting diode (LED) disposed to inject light into the collimating horn.

16. The luminaire of claim 9, wherein the light beam includes a collimation half-angle no greater than about 10 degrees.

17. The luminaire of claim 12, wherein the first angular spread and the second angular spread are each less than about 10 degrees.

18. The luminaire of claim 9, wherein the first vertex angle is about 37 degrees, and the second vertex angle is about 35 degrees.

19. The luminaire of claim 9, further comprising a battery to power the light source.

20. The luminaire of claim 19, further comprising a solar cell capable of charging the battery.

21. The luminaire of claim 9, wherein the light source is controlled by an attached switch, a wired connection, a wireless connection, a timer, or a combination thereof.

22. The luminaire of claim 9, further comprising a housing that at least partially encloses the light duct, the light output region, the asymmetric turning film, and the light source.

23. (canceled)
